(19) United States
(12) Patent Application Publication
(10) Pub. No.: US 2013/0269871 A1
(43) Pub. Date: Oct. 17, 2013

(54) LASER WELDING PLASTIC PARTS WITH TWO DEGREES OF FREEDOM

(71) Applicants: Oliver Roehl, Schlierbach (DE); Christoph Strasser, Dettingen (DE)

(72) Inventors: Oliver Roehl, Schlierbach (DE); Christoph Strasser, Dettingen (DE)

(21) Appl. No.: 13/880,781

(22) PCT Filed: Dec. 21, 2011
(86) PCT No.: PCT/EP11/73647

§ 371 Date: Jun. 28, 2013

(30) Foreign Application Priority Data
Dec. 21, 2010 (DE) 10 2010 055 293.3

(51) Int. Cl. B32B 37/06

(52) U.S. Cl. CPC B32B 37/06
USPC 156/272.2; 156/379.6

(57) ABSTRACT

The invention relates to a joining device (10, 20) and to a method for operating a joining device (10, 20), wherein a component (12, 22) comprising at least two parts is processed by means of an energy beam in such a way that the at least two parts are joined in a joining region by means of the energy beam, several components (12, 22) being fed and processed in succession by means of a conveying device (11, 21), characterized in that the energy beam by means of which the particular component (12, 22) is processed is moved along the joining region in dependence on the motion of the component (12, 22).

The invention relates to a method for operating a joining apparatus, wherein a component that consists of at least two parts is processed by means of an energy beam in such a manner that the at least two parts are joined in a joining region by means of the energy beam, wherein several components are supplied and processed one after the other by means of a conveying apparatus, as well as to a joining apparatus that operates as claimed in the method according to the features of the respective preambles of the independent claims.

DE 10 2007 042 0739 A1 makes known a method for operating a joining apparatus as well as a joining apparatus that operates as claimed therein. It makes known a clamping apparatus for clamping at least two parts of a component in a processing machine that is protected against radiation, the two parts being mounted in such a manner in the clamping apparatus that a pressure is generated in the joining region, that is in the two regions of the parts of the components that are to be joined together. By means of an energy beam, in this case a laser beam, the joining faces of the two parts that adjoin one another are heated up such that they melt together and are then non-detachably interconnected. The disadvantage of the processing machine, however, is that the two parts of the component have to be moved in, that they then are moved together and fixed in their position by means of the clamping apparatus, that the joining process is carried out after this and subsequently the finished component can be removed from the processing machine. Such a processing machine can easily be used for producing small quantities of components. However, it is not possible to produce large quantities economically in a series production using such a processing machine.

If the laser processing machine from DE 10 2007 042 0739 A1 had a conveying apparatus, the following sequence would be produced: component is moved into the laser processing machine→belt stops→where applicable component is removed or clamped by clamping mask→welding carried out by laser→component conveyed further. Disadvantages: clock pulse process, belt always has to carry out start/stop motions, the clock time for many moved elements (belt, removal mechanisms, clamping apparatus) is undesirably longer.

Consequently, for the application of series production of such components, non-cited DE 10 2011 055 460.2 has already proposed a method for the continuous welding of plastics material components of a product along a joining region that extends on the circumference, where the plastics material components to be welded are first of all moved into their joining position and are fixed there and, for welding, the product is then conveyed past a fixed heat source, the product being subject to a rotational self-movement in the region of the fixed heat source in addition to the conveying motion in order to introduce the welding energy into the joining region. The method is certainly better suited for series production, but still has the following disadvantages. On the one hand, the method can only be carried out if the product is subject to a rotational self-movement. This means that only rotationally symmetrical plastics material components can be processed using the method. A further disadvantage is that the energy beam is always focused precisely in one single point, the point corresponding to the joining region of the two parts of the plastics material component to be joined.

Consequently, the object underlying the invention is to provide a method for operating a joining apparatus as well as a joining apparatus that operates as claimed in the method, by way of which method or apparatus the advantages depicted in the introduction are avoided. In particular, it is to be possible to produce a large quantity of components economically and flexibly.

The object is achieved as claimed in the method in that the energy beam, by way of which the respective component is processed, is adjusted along the joining region in dependence on the motion of the component. As a result, in an advantageous manner, this is not only a question of a continuous motion of the component such that clock pulse advancement of the direction of motion (stop and go) can be omitted, but also the course of the energy beam is adapted to the motion of the component. Consequently, it is possible as claimed in the invention to join, in particular to laser weld, a contour (joining region) of the component whilst the component is being guided in its direction of motion through the joining apparatus (in particular the laser beam welding machine). This means that in an advantageous manner two motions are superposed, namely the motion of the component (consisting of two or more than two parts to be joined) in the direction of motion when running through the joining apparatus, and that at the same time the energy beam (laser beam) is adapted to the weld contour (joining region) with an additionally superposed motion for following the component advancement (component motion). This means in an advantageous manner for the realization of the invention that several components with parts that are to be joined can be supplied to the energy beam one after the other on a conveying apparatus of the joining apparatus. During the continuous conveying of the component, which can be effected in a linear, rotational or similar manner, the energy beam is first of all directed onto the joining region thereof, the energy beam traveling over the joining region by means of suitable means in order to connect together in a non-detachable manner the two parts of the component to be joined. The joining region, in this case, can be rotationally symmetrical, it also being possible, however, to realize other forms, such as, for example, rectangular, quadratic or oval or other joining regions. It is simply necessary to know the course of the joining region so that using simple means the laser beam can be adjusted in line with the joining region, the component being moved on at the same time on the conveying apparatus. Once the first supplied component is joined in its joining region and consequently is finished, the energy beam is directed onto the next supplied component and the procedure is carried out in the identical manner as has been described for the first component. Likewise, the procedure is the same for the next supplied components. The advantage of this overall is that components are supplied continuously one after the other without any interruption in the motion and can be processed in their joining region by means of the energy beam without interrupting the continuous motion of the component feed.

In a further development of the invention, the energy beam is adjusted by means of an optical apparatus along the joining region during the motion of the component. The advantage of this is that the source for generating the energy beam (in particular a laser beam source) can be arranged in a stationary manner, whereas the energy beam (in particular a laser beam) generated by the energy source is deflected by means of the optical apparatus. The deflection is effected in such a manner that the deflected energy beam is guided in a corresponding manner in line with the joining region and at the same time the progressive motion of the component is taken into account. This means that in this case too there are two superposed motions, namely first of all the motion of the energy beam for traveling over the joining region and at the same time a motion of the energy beam for taking into account the progressive motion of the component.

In a further development of the invention, the focus of the energy beam is adjusted to the joining region during the motion of the component. This means that the focus of the energy beam is tuned to or adjusted in such a manner to the operating region (joining region) that the focus does not have to be adjusted in the processing window (the point that is contacted by the energy beam precisely in the joining region). In reverse, this means that the focus is adjusted in view of the course of the point of the joining region to be processed as well as of the progressive motion of the component.

In a further development of the invention, the joining region is scanned during the motion of the component and the energy beam is adjusted in line with the joining region in dependence on the scanning operation. The advantage of this is that the joining region to be processed is automatically recognized by means of the scanning and consequently the energy beam can be adjusted along the scanned joining region whilst at the same time taking into account the progressive motion of the component during the conveying thereof. Consequently, in an advantageous manner arbitrary courses of joining regions are possible such that the method is not restricted to rotationally symmetrical components, but arbitrary joining regions are able to be processed.

The invention is explained in more detail and described below by way of the figures.

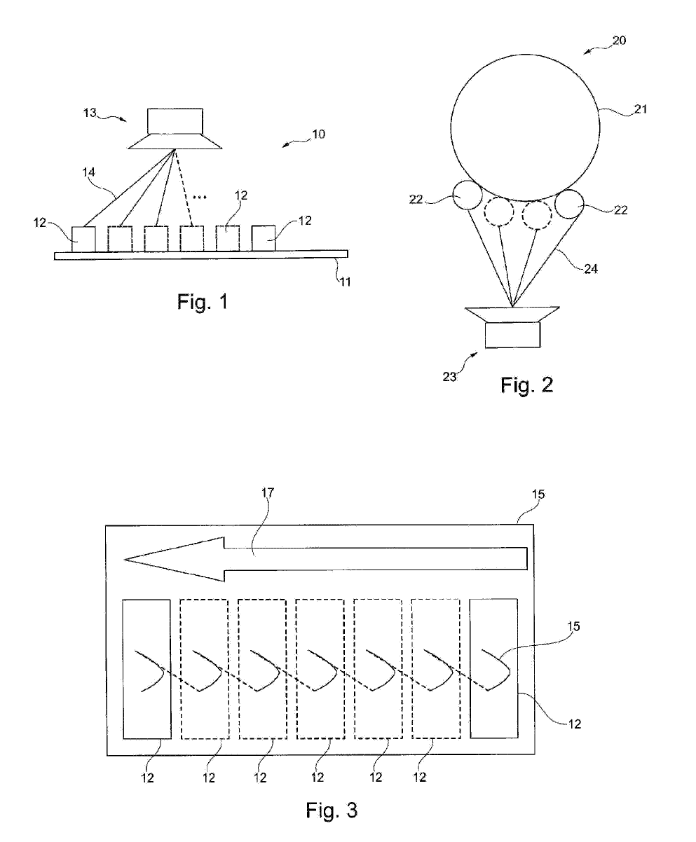

FIGS. 1 and 2, insofar as shown individually, in each case show a joining apparatus 10, 20. The respective joining apparatus 10, 20 includes a conveying apparatus 11, 21, the conveying apparatus 11 in FIG. 1 being shown as a conveyor belt, on which the components 12 are supplied one after the other and conveyed in a linear manner.

FIG. 2 shows a conveying apparatus 21 where the components 22, which are supplied one after the other, are moved in a rotational manner along a circular path. Whereas the components 12 on the conveying apparatus 11 according to FIG. 1 rest on the conveyor belt and have no relative motion with reference to the conveying apparatus 11, and must not have, the components 22 according to FIG. 2, with reference to their progressive motion along a circular path, at the same time also carry out a self-movement, preferably a rotational motion about their longitudinal axis. This means in addition, although without any restriction, that the linear conveying apparatus 11 according to FIG. 1 is used, as a rule, for non-rotationally symmetrical components 12, whereas the conveying apparatus 21 is preferably used for rotationally symmetrical components 22.

Although not shown in FIGS. 1 and 2, both the components 12 according to FIG. 1 and the components 22 according to FIG. 2 include at least two parts, preferably precisely two parts, which are to be joined in a non-detachable manner in a joining region (not shown either) by means of an energy charge. Such energy charges are known, for example, as laser beam welding, the named method being only an example and other methods obviously being able to be used for the purposes of charging energy into the joining region, bringing about a melting process there and then resulting in an undetachable join.

FIGS. 1 and 2 also show an energy beam apparatus 13, 23 that in each case generates an energy beam 14, 24. In a particularly advantageous manner, the energy beam apparatus 13, 23 includes a laser beam source for generating a laser beam. In addition, the energy beam apparatus 13, 23 includes, although does not show, an optical apparatus that is suitable and is realized for adjusting the respective energy beam 14, 24 along the joining region during the motion of the components 12, 22. Finally, the energy beam apparatus 13, 23 can also include a scanning apparatus such that the joining region is scanned during the motion of the components 12, 22 and the respective energy beam 14, 24 is adjusted in line with the joining region in dependence on the scanning operation.

The optical apparatus of the energy beam apparatus 13, 23 can be realized and can operate on the one hand such that the generated energy beam 14, 24 is moved along in view of the motion of the component 12, 22 along the joining region of the one component 12, 22. Once the joining region of the one component 12, 22 has been processed and consequently the two parts of the one component 12, 22 have been joined in a non-detachable manner, the energy beam 14, 24 can be directed to the next supplied components 12, 22 and there can travel over the joining region in view of the progressive motion of the next supplied component 12, 22. On the other hand, however, it is also conceivable that the generated energy beam 14, 24 is supplied at the same time not only to one component 12, 22 (as described above) but that through corresponding deflection, the energy beam 14, 24 changes (“jumps back and forth”) from one component 12, 22 to the next supplied component 12, 22 in the short-term in succession and in an alternating manner such that as a result the number of components to be processed in the run-through can be noticeably increased. In this case, depending on the processing speed of the energy beam 14, 24, its energy intensity and the speed of the progressive motion of the conveying apparatuses 11, 21, it cannot be ruled out that not only two components 12, 22 but more than two such components are processed at the same time.

FIG. 3 shows the processing sequence when joining at least two parts of a component (in this case as an example the component 12). A processing region of the energy beam 14, 24 is given the reference 15, the focus of the energy beam 14, 24 being able to move within the operating window. The weld line, which is produced by the motion of the energy beam 14, 24, in the joining region of the two parts of the component 12, 22 to be joined, is provided with the reference numeral 16. To complete the picture, the conveying direction of the components 12, 22 is shown by way of the reference 17.

In a preferred manner, laser beams are used as energy beams (heat sources). Likewise, a broadband infrared light source in the short or medium wave infrared range is suitable as a heat source, in particular a glass tube, ceramic, metal foil or carbon radiation emitter.

### LIST OF REFERENCES

10, 20 Joining apparatus

11, 21 Conveying apparatus

12, 22 Component

13, 23 Energy beam apparatus

14, 24 Energy beam

15 Processing region

16 Weld line

17 Conveying direction

1. A method for operating a joining apparatus, wherein a component that consists of at least two parts is processed by means of an energy beam in such a manner that the at least two parts are joined in a joining region by means of the energy beam, wherein several components are supplied and processed one after the other by means of a conveying apparatus, wherein the energy beam, by way of which the respective component is processed, is adjusted along the joining region in dependence on the motion of the component.

2. The method as claimed in claim 1, wherein the energy beam is adjusted along the joining region by means of an optical apparatus during the motion of the component.

3. The method as claimed in claim 1, wherein the focus of the energy beam is adjusted to the joining region during the motion of the component.

4. The method as claimed in claim 1, wherein the joining region is scanned during the motion of the component and the energy beam is adjusted in line with the joining region in dependence on the scanning operation.

5. A joining apparatus, wherein a component that consists of at least two parts is processed by means of an energy beam in such a manner that the at least two parts are joined in a joining region by means of the energy beam, wherein several components are supplied and processed one after the other by means of a conveying apparatus, wherein an energy beam apparatus is provided, wherein the energy beam, by way of which the respective component is processed, is adjusted along the joining region in dependence on the motion of the component.

6. The joining apparatus as claimed in claim 5, wherein the energy beam apparatus has an optical apparatus, wherein the energy beam is adjusted by means of an optical apparatus along the joining region during the motion of the component.

7. The joining apparatus as claimed in claim 5, wherein the energy beam apparatus has a scanning apparatus, wherein the joining region is scanned during the motion of the component and the energy beam is adjusted in line with the joining region in dependence on the scanning operation.

8. The joining apparatus as claimed claim 5, wherein the joining apparatus has a control apparatus.
